(19) United States
(12) Patent Application Publication
(10) Pub. No.: US 2015/0081435 A1
(43) Pub. Date: Mar. 19, 2015

(54) Targeted Advertisement Delivery

(71) Applicant: Barclays Bank PLC, London (GB)

(72) Inventor: Adam Griffiths, St Albans (GB)

(21) Appl. No.: 14/031,433

(22) Filed: Sep. 19, 2013

(51) Int. Cl. G06Q 30/02

(52) U.S. Cl. CPC G06Q 30/0255
USPC 705/14.53

(57) ABSTRACT

A system and method for controlling targeted offers for presentation to a consumer. A profile generator generates a user profile associated with a consumer, the user profile including a plurality of targeting parameters. The user profile is transmitted to at least one delivery platform configured to determine online advertising content relating to a product sold by a retailer that is to be displayed to the consumer, based on the user profile parameters. The system stores transaction data identifying attributes of a plurality of past purchases by a consumer at a respective plurality of different retailers, wherein the transaction data includes data identifying attributes of a purchase transaction by the consumer for the product or a similar product. The user profile is updated with at least one parameter identifying characteristics of the purchased product. The updated user profile is transmitted to the at least one delivery platform, whereby the deliver platform is configured to exclude online advertising content relating to the purchased product that is to be displayed to the consumer, based on the at least one parameter in the updated user profile.

### FIELD OF THE INVENTION

This invention relates to a targeted advertisement delivery system, and more particularly to improved systems and methods for the dynamic control of personalized ads to online users and devices based on historical behavior.

### BACKGROUND OF THE INVENTION

Conventionally, advertisers pay for advertising placement through a media placement agency, such as a third party advertising delivery platform. The advertising delivery platform determines and delivers personalized and targeted advertising content to users and devices, based on targeting parameters such as specified ad placement positioning and duration/timing. Advertisers are typically compensated based on the number and type of placements of the ad content and potentially the response rates of the customers measured by click-through rates. In some cases, the advertisers can track the customer all the way through to purchase (primarily online only). If the customer decides to compare and purchase the same product or service through another company, advertisers are still responsible for the advertising placements that the customer(s) may never respond to since they have already completed the purchase with an alternate retailer (merchant). This is particularly relevant to significant and infrequent purchases, such as package holidays and insurance.

U.S. Patent Application Publication No. 2011/0035278 and U.S. Patent Application Publication No. 2007/0288312 discuss systems that enable a particular retailer to match offline transactions with an online advertisement, to track and monitor the effectiveness of their targeted ads.

What is desired is a system and method for enabling optimization of the advertising spend for those advertisers who may not be aware when the customer has fulfilled their purchase with an alternative advertiser offline or through another online channel.

### SUMMARY OF THE INVENTION

According to one aspect of the present invention, a system is provided for controlling targeted advertising content for presentation to a consumer. The system comprises a user profile module generating a user profile associated with a consumer, the user profile including a plurality of targeting parameters. The personalized offers system transmits the user profile to at least one advertising delivery platform configured to determine online advertising content relating to a product sold by a retailer that is to be displayed to the consumer, based on the targeting parameters of the user profile. The system is configured to receive and store transaction data identifying attributes of a plurality of past purchases by a consumer at a respective plurality of different retailers, wherein the transaction data includes data identifying attributes of a purchase transaction by the consumer for the product or a similar product. The system further includes a profile updater configured to update the user profile with at least one targeting parameter identifying characteristics of the purchased product. The system is further configured to transmit the updated user profile to the at least one advertising delivery platform, whereby the advertising deliver platform is configured to exclude online advertising content relating to the purchased product that is to be displayed to the consumer, based on the at least one targeting parameter in the updated user profile.

In another aspect, the present invention provides a targeted advertisement delivery platform comprising a registered user database configured to receive a user profile associated with a consumer. The user profile includes a plurality of targeting parameters. The system also includes a targeted ad determiner configured to determine online advertising content relating to a product sold by a retailer that is to be displayed to the consumer based on the user profile parameters. The registered user database is further configured to receive an updated user profile including at least one targeting parameter identifying characteristics of a purchase transaction by the consumer for the product or a similar product purchased at a different retailer. Further, the targeted ad determiner is configured to exclude online advertising content relating to the purchased product that is to be displayed to the consumer, based on the at least one targeting parameter in the updated user profile.

In yet another aspect, the present invention provides a computer-implemented method controlling delivery of targeted advertisements. The method comprises generating a user profile associated with a consumer, the user profile including a plurality of targeting parameters. The user profile is transmitted to at least one advertising delivery platform configured to determine online advertising content relating to a product sold by a retailer that is to be displayed to the consumer, based on the user profile parameters. The method also includes receiving and storing transaction data identifying attributes of a plurality of past purchases by a consumer at a respective plurality of different retailers, wherein the transaction data includes data identifying attributes of a purchase transaction by the consumer for the product or a similar product. The user profile is updated with at least one targeting parameter identifying characteristics of the purchased product, and the updated user profile is transmitted to the at least one advertising delivery platform, whereby the advertising deliver platform is configured to exclude online advertising content relating to the purchased product that is to be displayed to the consumer, based on the at least one parameter in the updated user profile.

In a further aspect, the present invention provides a computer-implemented method controlling delivery of targeted advertisements. The method comprises the following steps: receiving a user profile associated with a consumer, the user profile including a plurality of targeting parameters; determining online advertising content relating to a product sold by a retailer that is to be displayed to the consumer based on the user profile parameters; receiving an updated user profile including at least one targeting parameter identifying characteristics of a purchase transaction by the consumer for the product or a similar product purchased at a different retailer; and excluding online advertising content relating to the purchased product that is to be displayed to the consumer, based on the at least one targeting parameter in the updated user profile.

In other aspects, there is provided a computer program arranged to carry out the method when executed by suitable programmable devices, and a non-transitory storage medium comprising said computer program.

### BRIEF DESCRIPTION OF THE DRAWINGS

There now follows, by way of example only, a detailed description of embodiments of the present invention, with references to the following figures identified below:

FIG. 1 is a block diagram showing the main components of an advertising delivery platform in a payment transaction environment, according to an embodiment of the invention;

FIG. 2, which comprises FIGS. 2a and 2b, is a flow diagram illustrating the main processing steps performed by components of the payment transaction environment of FIG. 1 for a process of controlling delivery of targeted advertisements according to an embodiment;

FIG. 3 is a flow diagram illustrating the main processing steps performed by a digital advertising platform for a process of updating user profiles according to an embodiment;

FIG. 4 is a flow diagram illustrating the main processing steps performed by the advertising delivery platform of FIG. 1 for a process of delivering targeted ads according to an embodiment; and

FIG. 5 is a diagram of an example of a computer system on which one or more of the functions of the embodiment may be implemented.

### DETAILED DESCRIPTION OF THE INVENTION

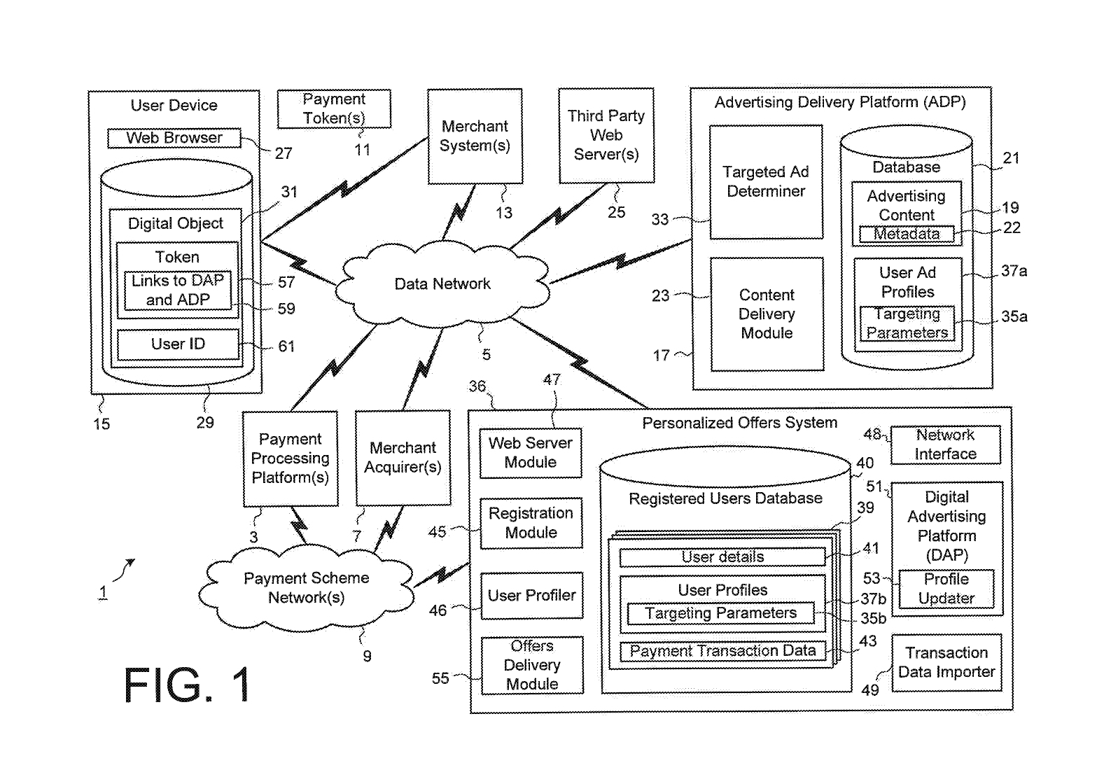

A specific embodiment of the invention will now be described for a process of dynamically controlling delivery of targeted ads (advertisements) based on customer's historical payment transaction data. Referring to FIG. 1, a payment transaction environment 1 according to an embodiment comprises one or more payment processing platforms 3 associated with respective payment account issuers. The payment processing platforms 3 facilitate the processing and completion of payment transactions between customers and merchants or retailers for the purchase of goods or services. The payment transactions may take place over any one of a number of channels (for example, in a store or via a data network 5, such as the Internet), and transaction settlement may involve routing of messages between components of the payment transaction environment 1, such as merchant acquirers 7 via associated payment scheme networks 9, as typically provided in conventional card payment systems.

For example, customers pay for goods and services by presenting payment tokens 11, such as credit or debit cards associated with respective payment accounts provided by the payment issuers, to a merchant system 13. As another example, the payment transaction is initiated via user (customer) devices 15 in electronic communication with respective interfaces, modules or components (not illustrated) of the merchant systems 13, such as a point of sale terminal and contactless/Near Field Communication (NFC) or conventional card reader, or a payment processing module of an online e-commerce website or hosted online payment service provider via the Internet 5.

As will be described below in greater detail, the payment transaction environment 1 also includes one or more advertising delivery platforms 17 that interact with the user device 15 to deliver targeted (personalized) ad content 19 from a respective database 21 to the associated user via a content delivery module 23. The ad content 19 can include a plurality of media content items that can be displayed by the user device 15, for example as an embedded advertisement in a web page. Each media content item is associated with metadata 22 identifying, for example, an associated merchant, product or product category, purchase cost or price range, discount rate, etc. Typically, one or more third party web servers 25 receive requests through the data network 5 from the user device 15 for one or more hosted web pages. The web pages can include code for embedding ad content 19 retrieved from an identified advertising delivery platform 17. The web servers 25 may also interact with an advertising delivery platform 17 to retrieve ad content 19 for requested web pages. The merchant systems 13 may also include respective web servers (not shown) hosting web pages for associated e-commerce websites.

The requested web pages are routed back to the user device 15 and displayed to the user via a web browser 27. The web browser 27 has access to a web objects database 29 storing web objects, such as cookies and digital objects 31 (such as flash objects) received from the web servers 25. The web browser 27 can also interact with the web objects database 29 to transmit the cookies and digital objects 31 back to the web servers 25 when a web page associated with the cookie or digital object 31 is requested. In another embodiment, a content delivery application (not shown) on the user device 15 can be used to interact with the web servers 25 and/or advertising delivery platform 17 to deliver targeted content to the user.

The advertising delivery platform 17 includes a targeted ad determiner 33 that determines ad content 19 relevant and/or beneficial to a user identified by a unique user ID 61, based on targeting parameters 35a stored in a user advertising profile 37a for the identified user. Examples of targeting parameters include but are not limited to: previous transactions by retailer, Merchant Category Code (MCC), location/date/time, servicing behavior (e.g. online, mobile, direct mail, etc.), demographics—(e.g. age, sex, marital status, children, preferences such as travel, food & drink, holidays, clothing, etc.). In this embodiment, the user advertising profiles 37a are received from a personalized offers system 36 that stores user data 39 for a plurality of registered users in a registered users database 40. The user data 39 is associated with respective unique user IDs 61, and includes user details 41, user profiles 37b and historical payment transaction data 43 associated with the registered users. Alternatively or additionally, the advertising delivery platform 17 can interact with the user device 15, the merchant systems 13, and/or the third party web servers 25 to receive data and update the targeting parameters 35a of the stored user advertising profiles 37a. The personalized offers system 36 interacts with die advertising delivery platform 17 over the data network 5 via a network interface 48.

A profile updater 53 of a digital advertising platform 51 maintains and updates the user profiles 37b, for example updating the targeting parameters 35b for the user profiles 37b based on characteristics and behaviors of the associated user identified from changes to the user details 41 and/or the historical payment transaction data 43 stored in the registered users database 40. The profile updater 53 can also take into account data from cookies and/or digital objects 31 received from the web browser 27 of the user device 15, in response to interactions with web pages transmitted to the user device 15 via the web server module 47. The personalized offers system 36 also includes a personalized offers delivery module 55 that determines personalized offers (such as digital coupons, vouchers, incentives, reward, or the like) for the user based on the user profile, and interacts with the user device 15 to deliver the personalized offers via the data network 5, whereby the personalized offer can be confirmed and applied to a purchase transaction, or output by the user device 15 for redemption at an associated merchant.

A registration module 45 of the personalized offers system 36 interacts with the user device 15 to receive and store the user details 41 for a new registered user, via one or more web pages stored and transmitted to the user device 15 by a web server module 47. A user profiler module 46 generates a user profile 37b for the registered user, based on user details 41 received during the registration process. After successful registration, the personalized offers system 36 also generates a digital object 31 for the registered user and user device 15, including a token 57 storing data identifying links 59 (addresses) to the digital advertising platform 51 and the advertising delivery platform 17, and a unique user/device identifier 61. The personalized offers system 36 interacts with the user device 15 to transmit the generated digital object 31 over the data network 5, to store the digital object 31 in the web objects database 29 of the user device 15. The web browser 27 of the user device 15 updates the stored digital object 31 with data identifying user activity in response to web browser interactions, and transmits the updated digital object 31 back to the digital advertising platform 51. The web browser 27 can be configured to monitor user activity via an installed plug-in component or the like, as is known in the art.

In an embodiment, the registered users' historical payment transaction data 43 include details of the respective user's payment transactions with different merchants via one or more payment processing platforms 3 associated with respective payment issuers, the details being received via a transaction data importer module 49. In an alternative embodiment, the personalized offers system 36 forms part of a payment processing platform 3 that processes payment transactions for the registered users and stores details of the processed transactions directly in the registered users database 40. In yet a further alternative embodiment, the digital advertising platform 51 itself forms part of a payment processing platform 3 and interacts details of processed transactions of users registered with the associated payment issuer, to update targeting parameters of user profiles stored by the payment processing platform 3.

The user device 15 can be any suitable computing device for facilitating a payment transaction with the merchant systems 11, such as a mobile smartphone, tablet computer, personal computer, etc. that includes software and/or hardware components, such as a web browser and/or mobile wallet (not illustrated), to communicate with the merchant systems 13, via a direct communication path, such as a wired, a Bluetooth®, NFC, infrared data connection, or the like, or via one or more suitable data communication networks 5 such as a wireless network, a local- or wide-area network including a corporate intranet or the Internet, using for example the TCP/IP protocol, or a cellular communication network such as Global System for Mobile Communications (GSM), General Packet Radio Service (GPRS), Code Division Multiple Access (CDMA), CDMA2000, Enhanced Data Rates for GSM Evolution (EDGE), Evolved High-Speed Packet Access (HSPTA+), Long Term Evolution (LTE), etc.

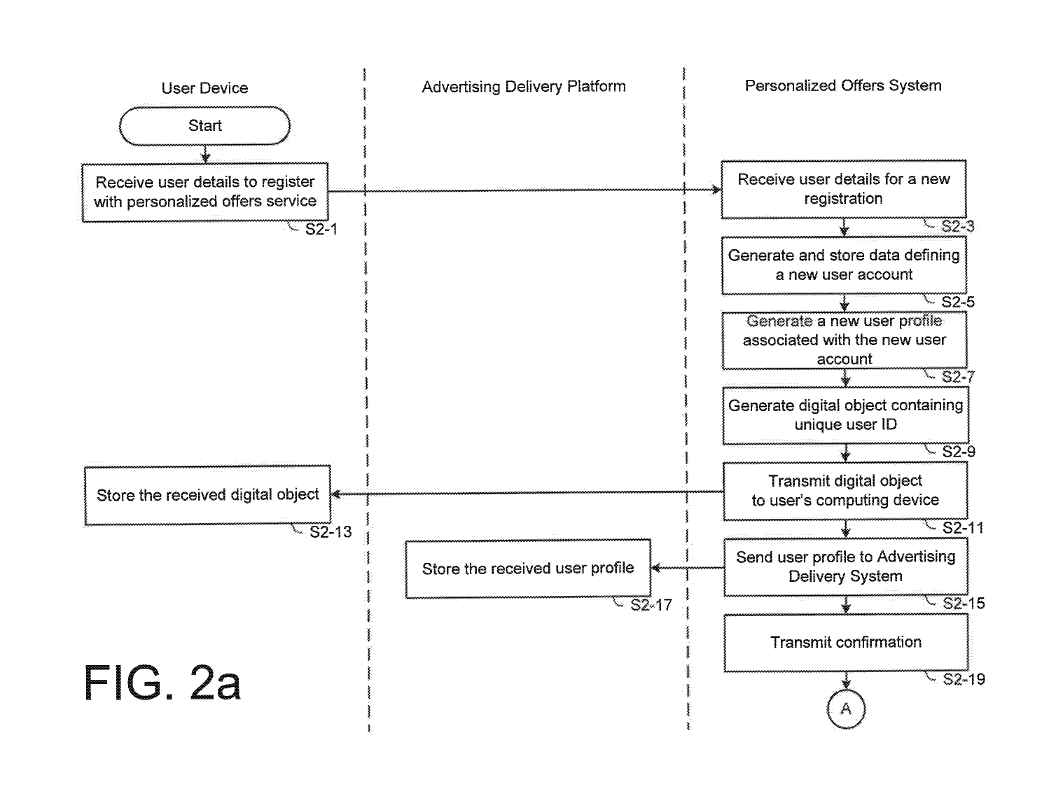

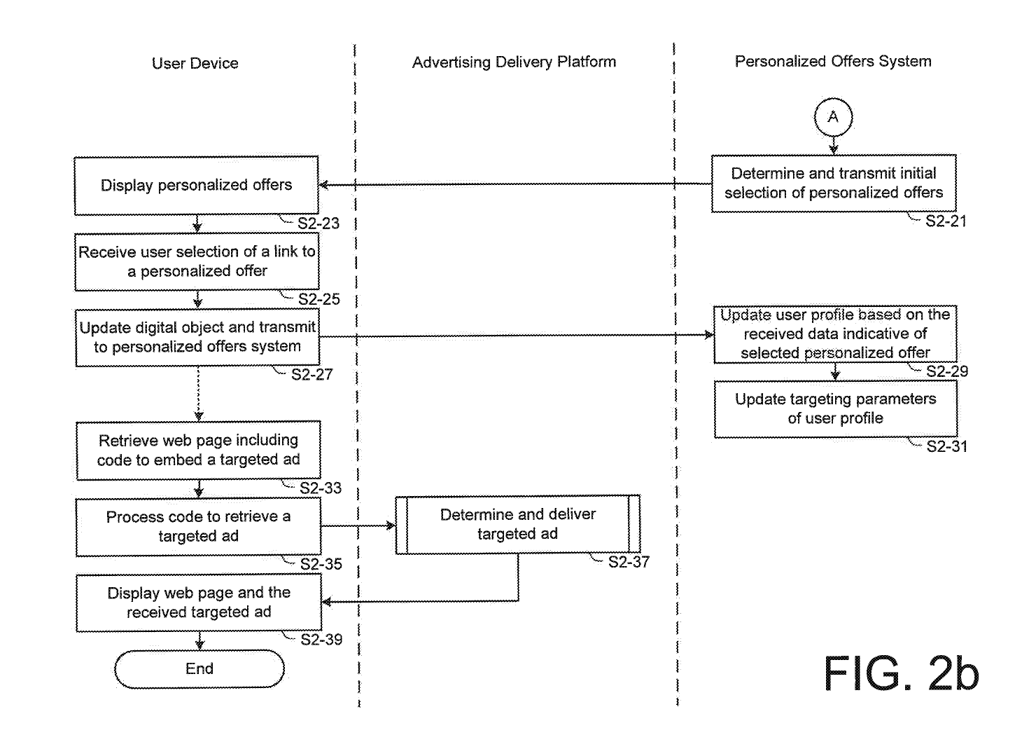

A brief description has been given above of the components forming part of the payment transaction processing system 3 of this embodiment. A more detailed description of the operation of these components in this embodiment will now be given with reference to the flow diagram of FIG. 2. The flow diagram describes a computer-implemented process of controlling delivery of targeted ads to a user device, using the digital advertising platform 51 and the advertising delivery platform 17.

As shown in FIG. 2, the process begins with registration of the user and/or the device with the personalized offers platform 35, if the user is not already a registered user of the personalized offers service provided by the personalized offers system 36, having associated user data 39 stored in the registered user database 40. The registration process is a typical secure registration process, via the web browser 27 on the user device 15, interacting with the registration module 45 of the personalized offers system 36, via the web server module 47 and the data network 5. Accordingly, at step S2-1, the user device 15 receives user details to register with the personalized offers service, in response to interaction with a received registration web page from the web server module 47, and transmits the received user details to the personalized offers system 36. The user details can include the user's name, postal address, email address, registered username, password/passcode, associated user device 15 identification data, etc. At step S2-3, the user details for the new registration are received by the registration module 45 of the personalized offers system 36. At step S2-5, the registration module 45 generates and stores user data 39 defining a new user account in the registered users database 40, the registered user data 39 including the user details 41 received from the user device 15. A unique user/device identifier is also generated for the new registered user and stored with the user details 41.

At step S2-7, the registration module 45 generates a new user profile 37b associated with the new user account, and stores the user profile in the registered users database 40. The user profile 37b includes data defining targeting parameters 35b associated with the registered user. The targeting parameters 35b are generated by a profiler module 46, based on predefined rules that match the initial user details 41 provided in the registration process with one or more defined targeting parameters indicative of characteristics of the user and/or user behavior.

After the new user is registered, the personalized offers system 36 generates, at step S2-9, a digital object 31 for the user device 15, including the unique user/device identifier 61 associated with the registered user details 41. The digital object 31 can also include a token 57 with data identifying links to the digital advertising platform 51 of the personalized offers system 36, and to one or more advertising delivery platforms 17. At step S2-11, the personalized offers system 36 transmits the generated digital object 31 to the user device 15, for example via the data network 5 using the web server module 47. At step S2-13, the digital object 31 is stored in the web objects database 29 of the user device 15.

In an alternative embodiment mentioned above, the personalized offers system 36 is provided as a component of, or is associated with, a payment processing platform of a financial institution. In this case, the user may be an existing registered customer of the financial institution and may not need to register for the personalized offers service. Moreover, the personalized offers system 36 in such an alternative embodiment will have access to existing user data 39 of the registered customers, including data identifying historical payment transactions processed by the payment processing platform for the customer.

At step S2-15, the personalized offers system 36 interacts with the advertising delivery platform 17 to send the user profile 37b for the new registered user, via the data network 5. At step S2-17, the advertising delivery platform 17 stores the received user profile 37b, including the associated targeting parameters 35b, as a targeted ad profile 37a for the user, in the local database 21. As will be described below, the targeted ad profile 37a is used by the advertising delivery platform 17 to determine and deliver targeted ad content 19 to the user device 15.

At step S2-19, the personalized offers system 36 transmits data to the user device 15 confirming successful registration with the personalized offers service. At step S2-21, the offers delivery module 55 determines an initial selection of personalized offers (such as digital coupons, vouchers, incentives, reward, or the like) to the user device 15, for example by matching one or more of the targeting parameters 35a of the user's targeted ad profile 37a with characteristics of the ad content 19 stored in the database 21. The personalized offers system 36 interacts with the user device 15 to transmit and deliver the determined selection of personalized offers to the user.

At step S2-23, the personalized offers are displayed by the user device 15, for example by the web browser 27. The personalized offers can be displayed as a web page including a plurality of links for the user to request details of, or to proceed with a process to redeem, one or more of the personalized offers. Accordingly, at step S2-25, the user device 15 receives a user selection of a link for a personalized offer. At step S2-27, the web browser 27 of the user device 15 updates the digital object 31 stored in the web objects database 29, with data indicative of the user's selected personalized offer. The web browser 27 also interacts with the personalized offers system 36 to transmit the updated digital object 31 to the digital advertising platform 51. At step S2-29, the digital advertising platform 51 of the personalized offers system 36 updates the stored user profile 37b based on the received data indicative of the selected personalized offer. At step S2-31, the profile updater 53 updates the targeting parameters 35b of the user profile 37b if necessary.

Although not illustrated in FIG. 2, a selected and redeemed personalized offer can be confirmed by the user and applied to a purchase transaction, or output by the user device 15 for redemption at an associated merchant.

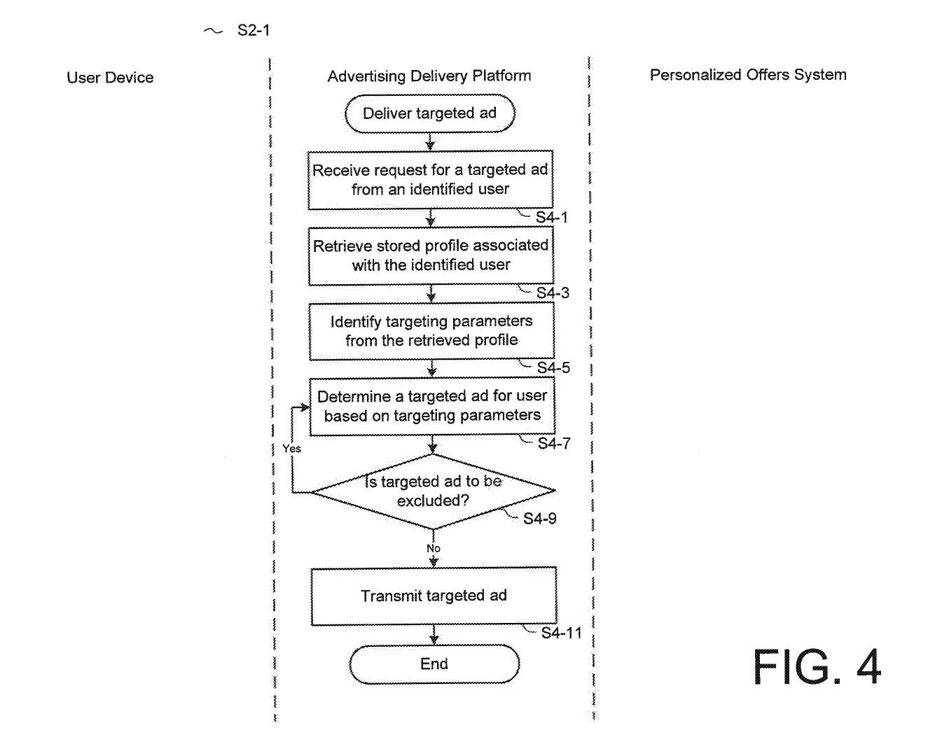

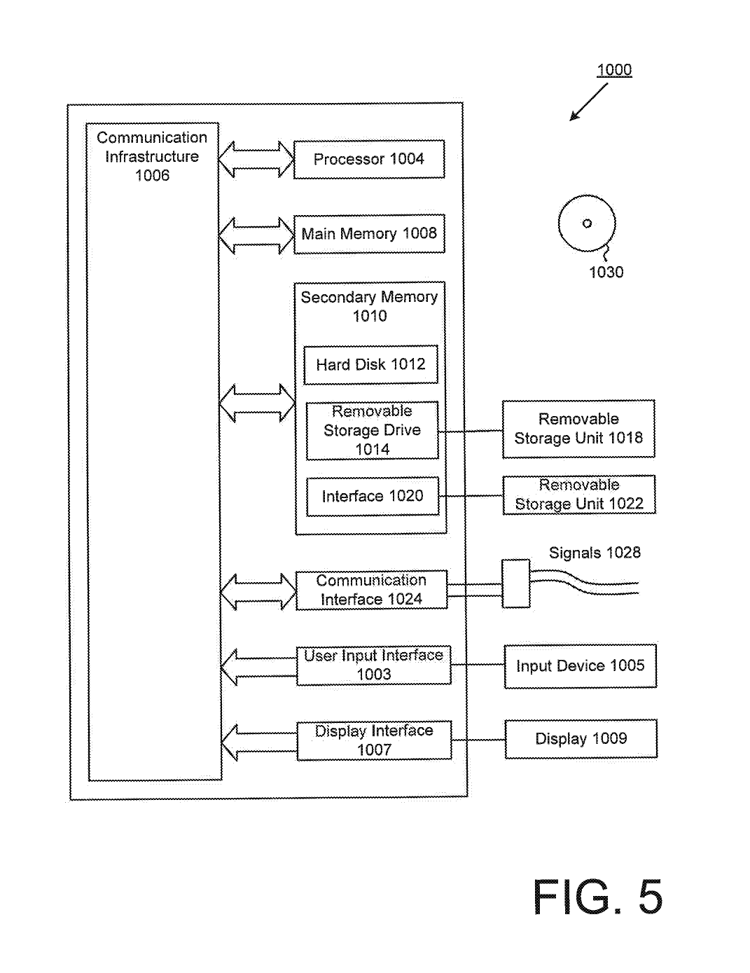

Subsequently, or in parallel with interaction with the displayed personalized offers, the user may interact with the web browser 27 to request one or more web pages from third party web servers 25, the web pages including one or more embedded advertisements targeting the user. Accordingly, at step S2-33, illustrated following a dashed line in FIG. 2b, the user device 15 retrieves a web page including code to retrieve an embedded targeted ad. The code for embedding ad content to a web page is of a type that is commonly known to those skilled in the art, and need not be described further. At step S2-35, the code is processed by the web browser 27 to retrieve one or more targeted ads, for example from an advertising delivery platform 17 identified in the code or from the link 59 in the token 57 of the digital object 31 stored in the web objects database 29. The advertising delivery platform 17 receives a request to deliver a targeted ad for the user, and determines and delivers a targeted ad at step S2-37, as will be described in greater detail below with reference to FIG. 4. At step S2-39, the web browser 27 displays the retrieved web page and the embedded targeted ad content received from the advertising delivery platform 17.

The web browser 27 can also update the digital object 31 in response to user interaction with the displayed targeted ad content, for example in response to user selecting a link associated with the displayed targeted ad content. Additionally, the web browser 27 can update the digital object 31 in response to general user search queries for a particular product or merchant, or a specific user search query at a particular merchant website.

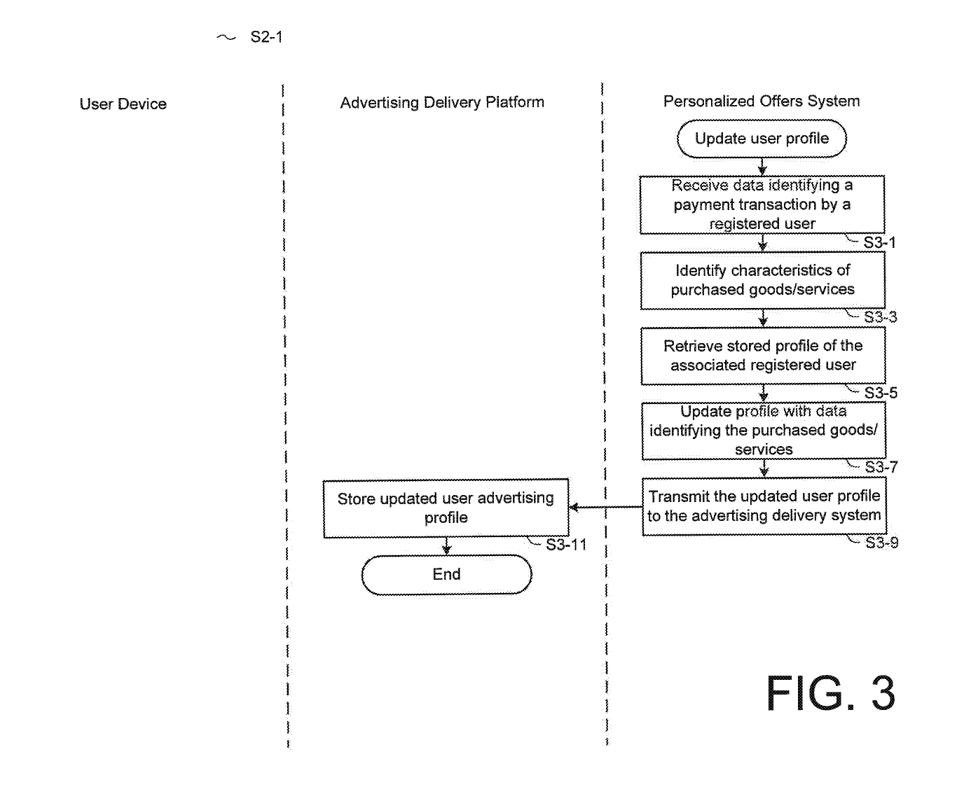

Referring now to FIG. 3, a more detailed description of the operation of the digital advertising platform 51 of the personalized offers system 36 and the advertising delivery platform 17 in this embodiment is provided for an examplary computer-implemented process of updating a stored user profile 37b based on data identifying a processed payment transaction for the user. As shown in FIG. 3, the update process begins at step S3-1 where the digital advertising platform 51 receives data identifying a payment transaction by a registered user that has been processed by a payment processing platform 3. The payment transaction may be associated with an online or offline purchase by the user at any particular merchant website or store. As discussed above, the processed payment transaction data may be received by a transaction data importer module 49 and may be stored as historical payment transaction data 43 in the registered users database 40.

The payment transaction data 43 typically includes a number of data elements associated with a purchased product or service at a particular merchant, for example:

| Transaction | | Merchant | | |
|---|---|---|---|---|
| ID | Date/Time | ID | Total | Payment Token ID |
| 10000001 | 2013-08-01 | Retailer A | 99.99 | 1111-2222- |
| | 12:30:01 | | | 3333-4444 |
| 10000002 | 2013-08-02 | Retailer B | 12.99 | 1111-2222- |
| | 17:01:32 | | | 3333-4444 |

At step S3-3, the profile updater 53 identifies characteristics of the purchased good(s) and/or service(s) associated with the processed payment transaction from data elements in the received payment transaction data. For example, the profile updater 53 determines a retailer category associated with the payment transaction, based on a predefined list mapping known merchant IDs to respective retailer categories. As another example, the profile updater 53 determines a price range characteristic based on the identified transaction amount.

Referring to the example payment transactions set out above, the profile updater 53 may identify the following characteristics for each purchase transaction:

| Transaction ID | Retailer Category | Price Range |
|---|---|---|
| 10000001 | Electronics | Medium |
| 10000002 | Phone Insurance | Low |
| 10000003 | Home insurance | High |
| 10000004 | Holidays | Medium |

Other exemplary types of identified characteristics include channel of purchase (e.g. online or offline), recency and frequency of previous similar purchases, detected smaller payments for associated administrative events, such as an automobile registration check (e.g. an HPI check) during a second hand car purchase, and/or a deposit to indicate commitment to purchase the car.

At step S3-5, the profile updater 53 retrieves the stored user profile 37b of the registered user associated with the payment transaction, and updates the targeting parameters 35b of the user profile 37b at step S3-7, with data identifying the processed purchases by the associated user, for example defined by the identified characteristics of the purchased goods and/or services. In an alternative embodiment, the payment transaction data may also include one or more data elements that uniquely identify a specific product and/or service, such as a stock-keeping unit (SKU) captured from the product by a merchant POS at the time of purchase, in order to more precisely match offers and targeted ads to the associated user. The profile updater 53 may also update other targeting parameters 35b of the user profile 37b based on the processed payment transaction data, such as the card type (credit/debt/scheme), location, amount and retailer category (e.g. MCC code).

At step S3-9, the digital advertising platform 51 transmits the updated user profile 37b to the advertising delivery platform 17. At step S3-11, the advertising delivery platform 17 stores the received updated user profile 37b as an updated user advertising profile 37a, including the data identifying past purchases by the associated user stored in the updated targeting parameters 35a.

In an alternative embodiment, the profile updater 53 can be configured to process batches of stored historical payment transaction data 43 to update the targeting parameters 35b of affected user profiles 37b at predetermined time intervals.

The process of delivering a targeted ad in step S2-37 above will now be described in more detail with reference to FIG. 4, which shows the computer-implemented steps carried out by the advertising delivery platform 17. As shown in FIG. 4, at step S4-1, the advertising delivery platform 17 receives a request for a targeted ad, including data identifying a requesting user (and/or user device 15). For example, the advertising delivery platform 17 receives a copy of the stored digital object 31 from the user device 15, including the user ID 61.

At step S4-3, the targeted ad determiner 33 retrieves the stored user advertising profile 37a for the identified user, and identifies the one or more targeting parameters 35a from the retrieved ad profile 37a at step S4-5. At step S4-7, the targeted ad determiner 33 determines a candidate media content item from the stored ad content 19 in the database 21 having metadata 22 that matches at least one of the identified targeting parameters 35a from the retrieved ad profile 37a. The matching process can be carried out according to a predefined algorithm or set of rules to determine a candidate ad content item 19.

For example, the ad content 19 stored in the database 21 of the application delivery platform 17 might include the following media content items and associated metadata 22:

| | | | | Targeting Metadata | | | |
|---|---|---|---|---|---|---|---|
| Media Content Item Specification | | | | | | Retail | |
| Content | Dimen- | Display | Duration/ | Gen- | | Cate- | Price |
| Item ID | sions | Position | Timing | der | Age | gory | Range |
| Banner- | 800 × | Top | Expires | Male | 18-35 | Elec- | Medium |
| 001 | 200 | | 2013 | | | tronics | |
| | | | Dec. 31 | | | | |

Consequently, the targeted ad determiner 33 may identify Banner-001 as a candidate match for an ad profile 37a with targeting parameters 35a identifying the user as a male, aged 30.

At step S4-9, the targeted ad determiner 33 determines if the candidate ad content item is to be excluded from display to the identified user. In this embodiment, the targeted ad determiner 33 compares the targeting metadata 22 of the candidate ad content item with the data identifying the processed purchases by the associated user, for example, defined by the identified characteristics of the purchased goods and/or services that was determined by the digital advertising platform 51 at step S3-7. In the example discussed above, the profile updater 53 identified the following characteristics for a historical purchase transaction:

| Transaction ID | Retailer Category | Price Range |
|---|---|---|
| 10000001 | Electronics | Medium |

Consequently, the targeted ad determiner 33 will determine that at least one of the targeting metadata elements matches a previous purchase transaction by the identified user (in this particular example, both the retailer category and the price range data elements match). Therefore, at step S4-9, the targeted ad determiner 33 determines that the identified ad content item is to be excluded from display to the identified user, because that user has purchased the same item or a similar item based on the matching characteristics. Processing returns to step S4-7 where the targeted ad determiner 33 determines another candidate targeted ad for the user.

On the other hand, if at step S4-9, the targeted ad determiner 33 determines that the metadata 22 associated with the candidate ad content item does not match any previous purchased transactions by the user, then at step S4-11, the content delivery module 23 transmits the identified targeted ad content 19 back to the requesting user device 15 (or web server 25).

In an alternative embodiment, the targeted ad determiner 33 may determine that a candidate targeted ad is to be excluded from display to the user if the targeting parameters 35a identify a matching prior purchase transaction that was processed within a predefined time window, such as within the past month.

A number of advantages will be understood from the above description of the embodiments of the present invention.

In particular, a system is provided that links a spend-linked digital offers platform, with a third party online advertising provider with the customer's digital device. The system expands the capabilities of the targeted advertising benefiting companies that have shifted a majority of ad spend to digital. In addition, the system increases the relevance of ads targeted to customers who subscribe to the digital offers product while shopping on 3rd party web sites.

Additionally, the system links the delivery of advertising content to customers spend across multiple retailers and channels. For example, if a customer has been viewing advertising for a one product but purchases a similar product from another brand or from another vendor, the system can identify this purchase through payment activity (issuing & acquiring). Once the payment activity has been confirmed, the advertising can cease. This allows advertisers to be more efficient with their advertising spend and not target customers for products or services that they no longer need.

The personalized offers system, advertising delivery platform, and user device described herein may be implemented by one or more computer systems such as a computer system 1000 as shown in FIG. 4. Embodiments of the present invention may be implemented as programmable code for execution by such computer systems 1000. After reading this description, it will become apparent to a person skilled in the art how to implement the invention using other computer systems and/or computer architectures.

The computer system 1000 includes one or more processors 1004. The processor 1004 may be any type of processor, including but not limited to a special purpose or a general-purpose digital signal processor. The processor 1004 is connected to a communication infrastructure 1006 (for example, a bus or network). Various software implementations are described in terms of this exemplary computer system. After reading this description, it will become apparent to a person skilled in the art how to implement the invention using other computer systems and/or computer architectures.

The computer system 1000 also includes a user input interface 1003 connected to one or more input device(s) 1005 and a display interface 1007 connected to one or more display(s) 1009. The input devices 1005 may include a pointing device such as a mouse or touchpad, a keyboard, a touchscreen such as a resistive or capacitive touchscreen, etc. After reading this description, it will become apparent to a person skilled in the art how to implement the invention using other computer systems and/or computer architectures, for example using mobile electronic devices with integrated input and display components.

The computer system 1000 also includes a main memory 1008, preferably random access memory (RAM), and may also include a secondary memory 610. The secondary memory 1010 may include a hard disk drive 1012 and/or a removable storage drive 1014, representing a floppy disk drive, a magnetic tape drive, an optical disk drive, etc. . . . The removable storage drive 1014 reads from and/or writes to a removable storage unit 1018 in a well-known manner. The removable storage unit 1018 represents a floppy disk, magnetic tape, optical disk, etc. . . . , which is read by and written to by the removable storage drive 1014. As will be appreciated, the removable storage unit 1018 includes a computer usable storage medium having stored therein computer software and/or data.

In alternative implementations, the secondary memory 1010 may include other similar means for allowing computer programs or other instructions to be loaded into computer system 1000. Such means may include, for example, a removable storage unit 1022 and an interface 1020. Examples of such means may include a program cartridge and cartridge interface (such as that previously found in video game devices), a removable memory chip (such as an EPROM, or PROM, or flash memory) and associated socket, and other removable storage units 1022 and interfaces 1020 which allow software and data to be transferred from the removable storage unit 1022 to the computer system 1000. Alternatively, the program may be executed and/or the data accessed from the removable storage unit 1022, using the processor 1004 of the computer system 1000.

The computer system 1000 may also include a communication interface 1024. The communication interface 1024 allows software and data to be transferred between the computer system 1000 and external devices. Examples of the communication interface 1024 may include a modem, a network interface (such as an Ethernet card), a communication port, a Personal Computer Memory Card International Association (PCMCIA) slot and card, etc. . . . Software and data transferred via a communication interface 1024 are in the form of signals 1028, which may be electronic, electromagnetic, optical, or other signals capable of being received by the communication interface 1024. These signals 1028 are provided to the communication interface 1024 via a communication path 1026. The communication path 1026 carries signals 1028 and may be implemented using wire or cable, fibre optics, a phone line, a wireless link, a cellular phone link, a radio frequency link, or any other suitable communication channel. For instance, the communication path 1026 may be implemented using a combination of channels.

The terms “computer program medium” and “computer usable medium” are used generally to refer to media such as the removable storage drive 1014, a hard disk installed in a hard disk drive 1012, and signals 1028. These computer program products are means for providing software to the computer system 1000. However, these terms may also include signals (such as electrical, optical or electromagnetic signals) that embody the computer program disclosed herein.

Computer programs (also called computer control logic) are stored in the main memory 1008 and/or the secondary memory 1010. Computer programs may also be received via the communication interface 1024. Such computer programs, when executed, enable the computer system 1000 to implement embodiments of the present invention as discussed herein. Accordingly, such computer programs represent controllers of the computer system 1000. Where the embodiment is implemented using software, the software may be stored in a computer program product 1030 and loaded into the computer system 1000 using the removable storage drive 1014, the hard disk drive 1012, or the communication interface 1024, to provide some examples.

Alternative embodiments may be implemented as control logic in hardware, firmware, or software or any combination thereof.

It will be understood that embodiments of the present invention are described herein by way of example only, and that various changes and modifications may be made without departing from the scope of the invention.

For example, in embodiments described above, a database of registered users is maintained, storing data including user details and user profiles, associated with respective unique user IDs. It will be appreciated additionally or alternatively, the database can store data associated with one or more registered user devices identified by unique machine identifiers and/or network address identifiers, and generate and maintain profiles based on identified activity and behaviors attributed with the registered user device.

In embodiments described above, user profile data is maintained by a personalized offers system and provided to an advertising delivery platform, to dynamically control selection and presentation of online advertising content to the respective user. It will be appreciated that instead of a personalized offers system managing the user profiles, a payment processing platform can instead be configured to carry out all of the user profile management aspects as described above, and to transmit updated user profile data to the one or more advertising delivery platforms.

What is claimed is:

1. A system comprising:
a user profile module configured to generate a user profile user profile associated with a consumer, the user profile including a plurality of targeting parameters;
at least one advertising delivery platform configured to determine online advertising content relating to a product sold by a retailer that is to be displayed to the consumer, based on the plurality of targeting parameters of a received user profile;
a database storing transaction data identifying attributes of a plurality of past purchases by a consumer at a respective plurality of different retailers, wherein the transaction data includes data identifying attributes of a purchase transaction by the consumer for the product or a similar product; and
a profile updater configured to update the user profile to produce an updated user profile with at least one parameter identifying characteristics of the purchased product;
wherein the user profile module is further configured to transmit the updated user profile to the at least one advertising delivery platform, whereby the at least one advertising delivery platform is configured to exclude online advertising content relating to the purchased product that is to be displayed to the consumer, based on the at least one targeting parameter in the updated user profile.

2. The system of claim 1, wherein the plurality of targeting parameters define consumer preferences and behaviors.

3. The system of claim 1, wherein the purchase transaction is an offline purchase transaction.

4. The system of claim 1, wherein the system further comprises a payment processing platform configured to process the purchase transaction by the consumer for the product or the similar product.

5. The system of claim 1, further comprising a personalized offers system for determining and delivering one or more personalized offers for the consumer based on the user profile.

6. The system of claim 1, further comprising a registration module for interacting with a computing device of a consumer to register the consumer with the system.

7. The system of claim 6, wherein the plurality of targeting parameters are determined from user details provided by the consumer.

8. The system of claim 6, wherein the personalized offers system is configured to generate and transmit a digital object to the computing device, wherein the digital object stores data identifying consumer activity.

9. The system of claim 8, wherein the computing device is configured to update the digital object to form an updated digital object in response to consumer activity.

10. The system of claim 9, wherein the computing device is configured to transmit the updated digital object to the system, and wherein the profile updater is configured to update the user profile based on the updated digital object.

11. The system of claim 9, wherein at least one targeting parameter in the updated user profile is determined from the attributes of the transaction data.

12. The system of claim 11, wherein the at least one targeting parameter in the updated user profile includes a retail category or a price range associated with the purchase transaction.

13. The system of claim 9, wherein the at least one targeting parameter in the updated user profile includes a time of the purchase transaction.

14. The system of claim 1, wherein the profile updater is configured to update the user profile in response to receiving data for a processed transaction.

15. A targeted advertisement delivery platform comprising:
a registered users database configured to receive a user profile associated with a consumer, the user profile including a plurality of targeting parameters; and
a determiner configured to determine online advertising content relating to a product sold by a retailer that is to be displayed to the consumer based on the user profile;
wherein the registered users database is further configured to receive an updated user profile including at least one targeting parameter identifying characteristics of a purchase transaction by the consumer for the product or a similar product purchased at a different retailer; and
wherein the determiner is further configured to exclude online advertising content relating to the purchased product that is to be displayed to the consumer, based on the at least one targeted parameter in the updated user profile.

16. A computer-implemented method for controlling delivery of targeted advertisements, the method comprising steps performed by one or more processors of:
generating a user profile associated with a consumer, the user profile including a plurality of targeting parameters;
transmitting the user profile to at least one advertising delivery platform configured to determine online advertising content relating to a product sold by a retailer that is to be displayed to the consumer, based on the plurality of targeting parameters of the user profile;
receiving and storing transaction data identifying attributes of a plurality of past purchases by a consumer at a respective plurality of different retailers, wherein the transaction data includes data identifying attributes of a purchase transaction by the consumer for the product or a similar product;
updating the user profile with at least one targeting parameter identifying characteristics of the purchased product to form an updated user profile; and
transmitting the updated user profile to the at least one advertising delivery platform, whereby the at least one delivery platform is configured to exclude online advertising content relating to the purchased product that is to be displayed to the consumer, based on the at least one targeting parameter in the updated user profile.

17. A computer-implemented method for controlling delivery of targeted advertisements, the method comprising steps performed by one or more processors of:
receiving a user profile associated with a consumer, the user profile including a plurality of targeting parameters;
determining online advertising content relating to a product sold by a retailer that is to be displayed to the consumer based on the user profile parameters;
receiving an updated user profile including at least one targeting parameter identifying characteristics of a purchase transaction by the consumer for the product or a similar product purchased at a different retailer; and
excluding online advertising content relating to the purchased product that is to be displayed to the consumer, based on the at least one targeting parameter in the updated user profile.
